(19) United States
(12) Patent Application Publication
(10) Pub. No.: US 2004/0022329 A1
(43) Pub. Date: Feb. 5, 2004

(54) Single chip CMOS RF receiver included PLL therein

(76) Inventor: Ching-Lieh Sun, Hsin-Chu City (TW)

Correspondence Address: HARNESS, DICKEY & PIERCE, P.L.C., P.O. BOX 8910, RESTON, VA, 20195, US

(21) Appl. No.: 10/462,716

(22) Filed: Jun. 17, 2003

(30) Foreign Application Priority Data
Jun. 20, 2002 (TW) 91209497

(51) Int. Cl. H04L 27/06

(52) U.S. Cl. 375/316; 375/376

(57) ABSTRACT

A single chip CMOS RF receiver included PLL is provided, including: a channel selectable PLL, LNA & MIXER, IF amplifier, demodulator, and zero cross transformer. The LNA & MIXER receives an antenna signal and PLL signal, and generates IF signal. Then, through IF amplifier amplifies IF signal. After the demodulator and the zero cross transformer processing, the carrier wave is made. Wherein, the selectable PLL can generate several RF signals, which is controlled by a external setting signal that is serial or parallel.

### BACKGROUND OF THE INVENTION

1. Field of the Invention

The present invention relates to radio frequency receiver, and more particularly to a single chip CMOS RF receiver included PLL therein.

2. Related Background Art

Recently, the computer peripheral devices, such as mouse, keyboard and other input devices, are affected by another new trend. The new trend of peripheral devices is marked as wireless revolution. That is, every devices that communicate with other device in a wire way will change their communicate way by wireless technology.

For example, there are two architectures used in the wireless mouse or wireless keyboard in the market: IR or RF. The former one is limited in the transmission direction and angle. Rather, there are no such limits of the latter one.

Until now, most solutions of the wireless mouse or wireless keyboard architecture utilize only one or two frequencies, for example, 27.125 MHz or 27.145 MHz. Therefore, when using several wireless products that use the same architecture will encounter interference problem. Moreover, the components of the wireless device above are separated apart. That is, system manufacturer has to make more efforts on preparing plenty stocks for the components. Besides, for avoiding the interference problem, system manufacturer has to use different quartz oscillators to generate different frequencies, and has to face the problem for cost increasing and another stocks.

The most important part of the RF system is RF receiver. In the RF receiver architecture, Phase Lock Loop (PLL) is used to enable the system synchronization, clock recovering, or data recovering, and frequency synthesis. Therefore, PLL is the most important part of a RF system.

Furthermore, accompanying with the development of Complementary Metal Oxide Semiconductor (CMOS) manufacture technique, the RF device such as wireless mouse and wireless keyboard can be designed in CMOS technology. Until now, the PLL part is still made as individual chip. Because of the interference problem, the RF receiver single chip integrated with PLL solution does not success yet.

Therefore, how to make the RF receiver integrated with PLL is a research subject of RF system manufacturer.

### SUMMARY OF THE INVENTION

It is therefore an object of the present invention to provide a single chip CMOS RF receiver included PLL therein, which can adjust the radiation frequency and has the low cost effect.

It is another object of the present invention to provide a single chip CMOS RF receiver included PLL therein, which can use in the low frequency band for wireless mouse, wireless keyboard and other applications, for example 27 MHz. The present invention can utilize Frequency Shift Keying (FSK) or Minimum Shift Keying (SK) modulation technologies to generate modulated signals. The present invention includes: a channel selectable PLL, a LNA & MIXER, an IF (intermediate frequency) amplifier, a Demodulator, and a zero cross transformer. The PLL can generate a plural of radio frequency (RF) signals, but is selected to output one. The LNA & MER is coupling to the PLL for receiving a signal from an antenna, mixing the signal and the RF signal and to generate an IF signal. IF Amplifier accepts the IF signal and amplifies it. Demodulator is used to accept and demodulate the IF signal for generating a carrier wave signal. The zero cross transformer is used to accept and amplify the carrier wave for sending to a control unit for further processing.

The channel selectable PLL includes: prescaler & N counter, Voltage control oscillator (VCO), Oscillator, Reference counter, Phase Detector (PD), and Control logic. The control logic is used to accept a channel control signal to output a frequency select code for control the plurality RF signals generating. The voltage control oscillator (VCO) is used to generate the RF signals. The prescaler & N counter is connected with the control logic and the VCO, which is used to accept the channel select code, decide a scaler value, and output a feedback signal created by the RF signal divided by the scaler value. The oscillator is used to accept an input clock and generate a higher frequency digital signal. The reference counter is connected with the oscillator, which is used to accept the higher frequency digital signal and output a reference frequency signal. The Phase detector (PD) is connected with the prescaler & N counter and the reference counter, which is used to compare the feedback signal and the reference frequency signal and output a difference signal to an external second filter for filter out high frequency signal, then send to an external resonant unit.

### BRIEF DESCRIPTION OF THE DRAWING

The invention can be more fully understood by the following derailed description of the preferred embodiment, with accompanying drawings as following:

FIG. 1 is the function block of the present invention of single chip CMOS RF receiver included PLL; and

FIG. 2 is the function block of the PLL.

### DETAILED EDSCRIPTION OF PREFERRED EMBODIMENT

The invention can be utilized in the low frequency band, which are regulated by the regulations of “Technical Provisions for Low Power Radio devices” of the defined country, for example, LP0002-3.3 of R.O.C, FCC PART 15 Section 15.227 of U.S.A, ETSI I-ETS 300 220, etc.

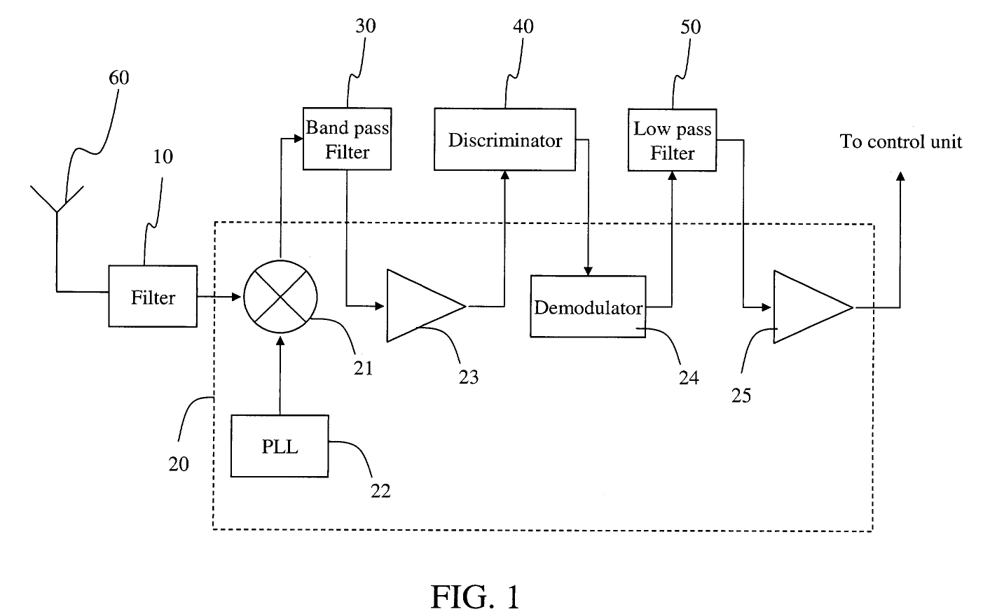

FIG. 1 discloses the function block of the present invention of single chip CMOS RF receiver included PLL. The CMOS RF receiver single chip included PLL 20 comprises: Low noise amplifier & mixer (LNA & MIXER) 21, Phase Lock Loop (PLL) 22, IF Amplifier 23, Demodulator 24 and Zero Cross Transformer 25. The LNA & MIXER 21 is connected with the external filter 10, which accepts the RF signal receiving from the antenna 60, and filtered by the filter 10.

The PLL 22 is selectable multi-channel one (channel selectable PLL), which can generated several different frequencies of RF signals. The PLL 22 is connecting with the LNA & MIXER 21. The LNA & MIXER 21 is used to amplify the target small signal receiving from the antenna 60 and calculate the amplified small signal with the local signal generated by the PLL 22 for removing the RF signal and generate an intermediate frequency (IF) signal. For example, when using in 27 MHz RF domain, IF signal can be 455 kHz. Between the LNA & MIXER 21 and the IF amplifier 23 is a band pass filter 30, which is used to filter out the signals that are not IF signal part. For example, the band of the band pass filter 30 can be 455 kHz described above.

After filtering, the IF signal is quite small to be detected, therefore, IF amplifier 23 is needed. After amplifying, the amplified IF signal is sent to discriminator 40 to make quadrature processing for acquiring the carrier wave. After the quadrature processing, the signal is then sent to the demodulator 24.

Due to the low frequency of the carrier wave acquiring from the demodulator 24, it is needed to use a low pass filter 50 to filter out the high frequency signals. After the passing the filter 50, the signal is the target carrier wave. Finally, the Zero cross transformer 25 amplifies or transforms the carrier wave into carrier signals to send to the control unit for further processing.

The multi-channel design of the PLL 22 provides different devices various working frequencies, which can reduce the interference problem of the RF signals in a same specific space. The solution is to select a same working frequency with the RF transmitter in the PLL 22. The detailed description of PLL 22 is depicted as following:

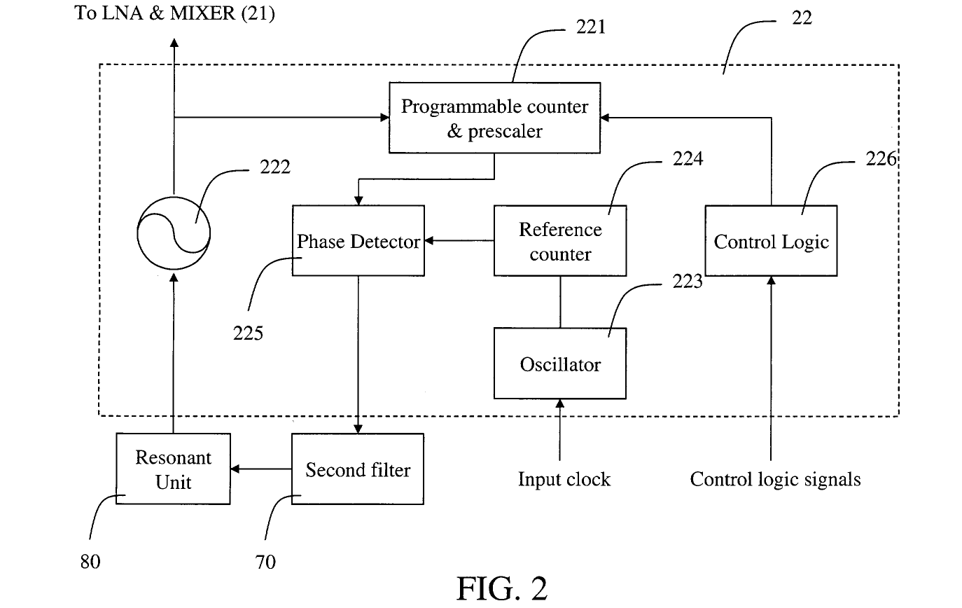

Please refer to FIG. 2. PLL 22 includes several parts: prescaler & N counter 221, Voltage control oscillator (VCO) 222, Oscillator (Oscillator) 223, reference counter 224, Phase Detector (PD) 225, and control logic 226.

VCO 222 is used as local oscillation for generating RF signals. Control logic 226 is used to receive the channel control signals from outside, and output a frequency select code to control the RF signals described above. The control logic 226 has two structure types: serial control or parallel control. For example, using 4 bit D0˜D3 parallel BCD control to change different channel. The present invention integrates these two types for system programmer to choose.

Both the frequency select code of the control logic 226 and the RF signal generated by the VCO 222 are sent to the prescaler & N counter 221. The prescaler & N counter 221 decides a scaler value according to the frequency select code. The frequency select code is set inside the prescaler & N counter 221 beforehand. The prescaler & N counter 221 uses the RF signal dividing the scaler value to generate the feedback signal.

Oscillator 223 is connected with the input clock port to generate high frequency digital signal. The reference counter 224 is connected with the oscillator 223 for accepting the high frequency digital signal, and output a reference frequency to Phase Detector (PD) 225. PD 225 is connected with the prescaler & N counter 221 and connected the external second filter 70. PD 225 is used to compare the feedback signal and the reference frequency, and send the difference signal of the two kinds of signals to the second filter 70 to filter out the high frequency. Then, the difference signal is sent to the external resonant unit 80.

After receiving the difference signal,.the resonant unit 80 passes the difference signal to the VCO 222 to generate the RF signal.

The second filter 70 and resonant unit 80 have high impedance, therefore, it is not suite to design in the single chip.

Practically, 27 MHz frequency domain can set the oscillating frequency of the oscillator 223 as 4 MHz or 6 MHz, and the scaler value of the reference counter 224 can be set as 800 or 1200. That is, the reference frequency of reference counter 224 is 5 kHz, and the scaler value of the prescaler & N counter 221 can be set as 5 k, which is adjustable according to channel amount. Other frequency domain can use the structure of the present invention.

Utilizing the present invention can have several benefits. Firstly, due to the multi-channel design, user can set different frequency channel in different device, which can avoid the interference problem. Secondly, system manufacturer can lower down the stocks generate by the lowest components due to the single chip solution.

The invention has been described using exemplary preferred embodiment. However, it is to be understood that the scope of the invention is not limited to the disclosed embodiments. On the contrary, it is intended to cover various modifications and similar specifications. The scope of the claims should be interpreted to involve all such modifications and specifications.

What is claimed is:

1. A single chip CMOS RF receiver included PLL therein, comprising:
a channel selectable Phase Lock Loop (PLL), used to generate a plurality of RF signals and output one;
a low noise amplifier (LNA) & MIXER, connected with said PLL, which is used to accept a signal received by a external antenna and the RF signal generated by said PLL, and mix said signal and said RF signal for generating an IF signal;
an IF amplifier, used to accept and amplify the said IF signal;
a demodulator, used to accept and demodulate said amplified IF signal for generating a carrier wave signal; and
a zero cross transformer, used to accept and amplify the carrier wave signal for sending to a control unit for further processing.

2. The single chip of claim 1, wherein said antenna and said LNA & MIXER are connected through a filter, used to filter out the signal other than the RF signal.

3. The single chip of claim 1, wherein said LNA & MIXER and said IF amplifier are connected through a band pass filter for filtering the signals rather than the IF signal generated by said LNA & MIXER.

4. The single chip of claim 1, wherein said IF amplifier and said demodulator are connected through a Discriminator, used to make quadrature processing.

5. The single chip of claim 1, wherein said demodulator and said zero cross transformer are connected a low pass filter, used to filter out high frequency signals.

6. The single chip of claim 1, wherein said channel selectable PLL includes:
a control logic, used to accept a channel control signal to output a frequency select code for control said plurality RF signals generating;
a voltage control oscillator (VCO), used to generate said RF signals;
a prescaler & N counter, connected with said control logic and said VCO, which is used to accept said channel select code, decide a scaler value, and output a feedback signal created by said RF signal divided by said scaler value;
an oscillator, used to accept an input clock and generate a higher frequency digital signal;
a reference counter, connected with said oscillator, which is used to accept said higher frequency digital signal and output a reference frequency signal; and
a phase detector PD), connected with said prescaler & N counter and said reference counter, which is used to compare said feedback signal and said reference frequency signal and output a difference signal to an external second filter for filter out high frequency signal, then send to an external resonant unit.

7. The single chip of claim 6, wherein said channel control signal is serial control signal.

8. The single chip of claim 6, wherein said channel control signal is parallel control signal.

9. The single chip of claim 6, wherein the frequency of said oscillator is selected from the group of 4 MHz and 6 MHz.

10. The single chip of claim 7, wherein the reference frequency of said reference counter is 5 kHz.
